(19) United States
(12) Patent Application Publication
(10) Pub. No.: US 2011/0073019 A1
(43) Pub. Date: Mar. 31, 2011

(54) SAFE ANCHORING DEVICE

(76) Inventor: Leslie Ho Leung Chow, Shilouzhen (CN)

(21) Appl. No.: 12/568,509

(22) Filed: Sep. 28, 2009

(51) Int. Cl. E05G 1/02; E05G 1/00

(52) U.S. Cl. 109/50

(57) ABSTRACT

A safe anchoring device for anchoring a safe to a floor. In addition to anchoring the safe, the safe anchoring device simultaneously provides a watertight and airtight seal for the interior of the safe. A tunnel connects the interior housing to the exterior housing. Insulation is between the interior housing and the exterior housing. A removable top cover covers the tunnel on the inside of the safe at the interior housing. When the anchoring device is used to anchor the safe to the floor, a removable threaded locking bolt extends through the tunnel and is threaded onto a threaded tube section of a bottom cover while the bottom cover is securely attached to the floor. In a preferred embodiment, when the safe is anchored to the floor the watertight and airtight seal is provided by a gasket under the top cover and an O-ring under the bolt head of the threaded locking bolt. When the safe is not anchored to the floor, the threaded locking bolt is removed and the bottom cover covers the tunnel at the exterior housing. In a preferred embodiment, when the safe is not anchored to the floor the watertight and airtight seal is provided by gaskets under the top cover and the bottom cover.

The present invention relates to safes, and in particular, to anchoring devices for safes.

### BACKGROUND OF THE INVENTION

Currently, safes are mainly used for the storage of valuables such as jewelry. However, as society progresses and as the economy expands, bank books, cash, identification and other important documents also need to be stored. Additionally, as computer technology develops, computer media records including hard drives and diskettes need to be stored appropriately.

Thieves, if they are unable to break into a safe at its location, will often try to remove the safe to a different location. To combat this, in the prior art there are safes which are secured to the ground through bolts screwed through the bottom of the safe. However, these prior art anchoring devices are known to have inadequate sealing capabilities.

It is important that a safe always has a proper seal to protect the contents stored inside the safe. When a safe is submerged in water, if the sealing is inadequate, water will go into the safe and destroy the contents within. Moreover, if the sealing is inadequate, contents can also be destroyed by humidity or smoke and heat from a fire. Hence, a safe not only needs good anti-theft properties but also needs be highly sealed which can provide water-proof, anti-humidity and fire proof qualities.

What is needed is a better safe anchoring device.

### SUMMARY OF THE INVENTION

The present invention provides a safe anchoring device for anchoring a safe to a floor. In addition to anchoring the safe, the safe anchoring device simultaneously provides a watertight and airtight seal for the interior of the safe. A tunnel connects the interior housing to the exterior housing. Insulation is between the interior housing and the exterior housing. A removable top cover covers the tunnel on the inside of the safe at the interior housing. When the anchoring device is used to anchor the safe, a removable threaded locking bolt extends through the tunnel and is threaded onto a threaded tube section of a bottom cover while the bottom cover is bolted into the floor. In a preferred embodiment, when the safe is anchored to the floor the watertight and airtight seal is provided by a gasket under the top cover and an O-ring under the bolt head of the threaded locking bolt. When the safe is not anchored to the floor, the threaded locking bolt is removed and the bottom cover covers the tunnel at the exterior housing. In a preferred embodiment, when the safe is not anchored to the floor the watertight and airtight seal is provided by gaskets under the top cover and the bottom cover.

### BRIEF DESCRIPTION OF THE DRAWINGS

FIG. 1 shows a preferred embodiment of the present invention during safe transport.

FIG. 2 shows an exploded view of some of the components of a preferred embodiment.

FIGS. 3-6 illustrate a preferred method for anchoring a safe to the floor.

FIG. 7 shows a preferred top cover.

FIG. 8 shows preferred screw sleeves.

FIG. 9 shows a preferred bottom cover.

FIG. 10 shows a preferred locking mechanism inside a safe.

FIG. 11 shows a side view of a safe anchored to the floor.

### DETAILED DESCRIPTION OF A PREFERRED EMBODIMENT

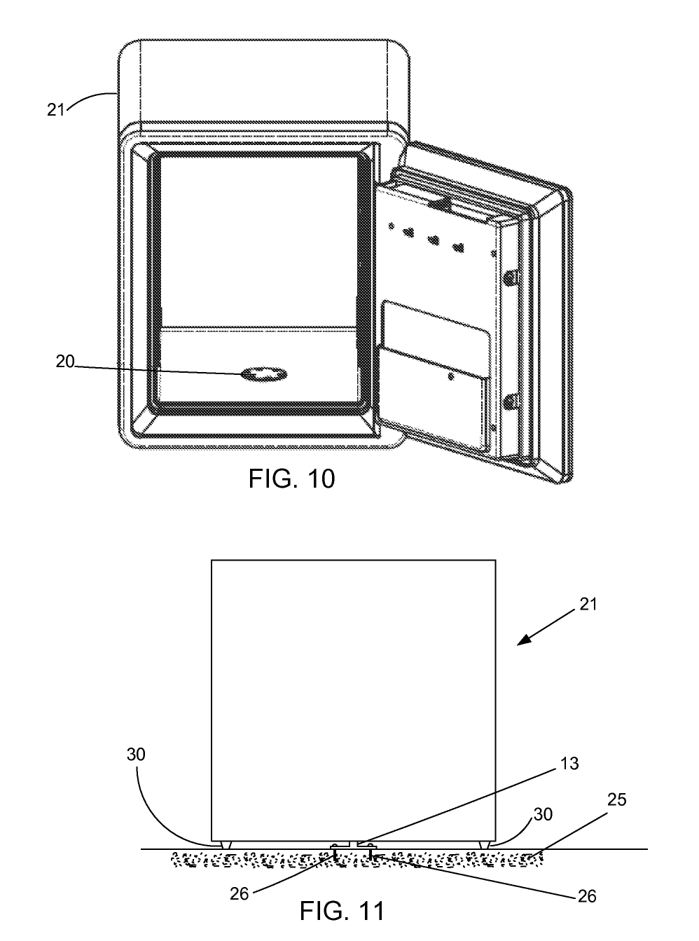

FIG. 10 shows a perspective view of a preferred embodiment of the present invention. Locking mechanism 20 is utilized to anchor safe 21 to the floor while at the same time providing airtight and watertight protection for the interior of safe 21.

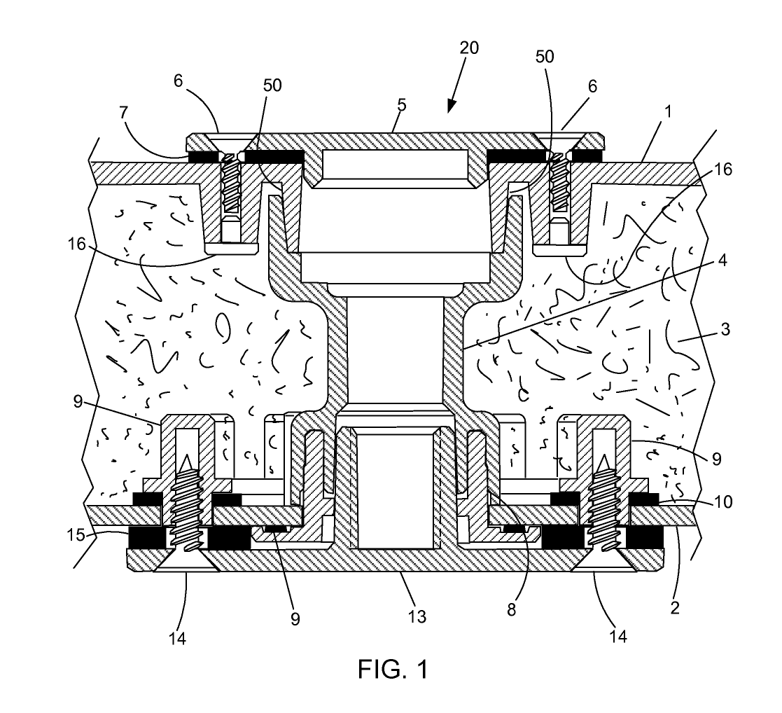

FIG. 1 shows a preferred embodiment of the present invention. When configured as shown in FIG. 1, locking mechanism 20 is not being used to secure safe 21 to the floor. However, it is still able to provide watertight and airtight protection for the interior of the safe. For example, FIG. 1 shows the condition of locking mechanism 20 during the time in which it is being shipped to a customer or during a time in which it is being transported from one location to another. In FIG. 1, the interior of safe 21 is protected from water, humidity and smoke by virtue of gaskets 15 and 7.

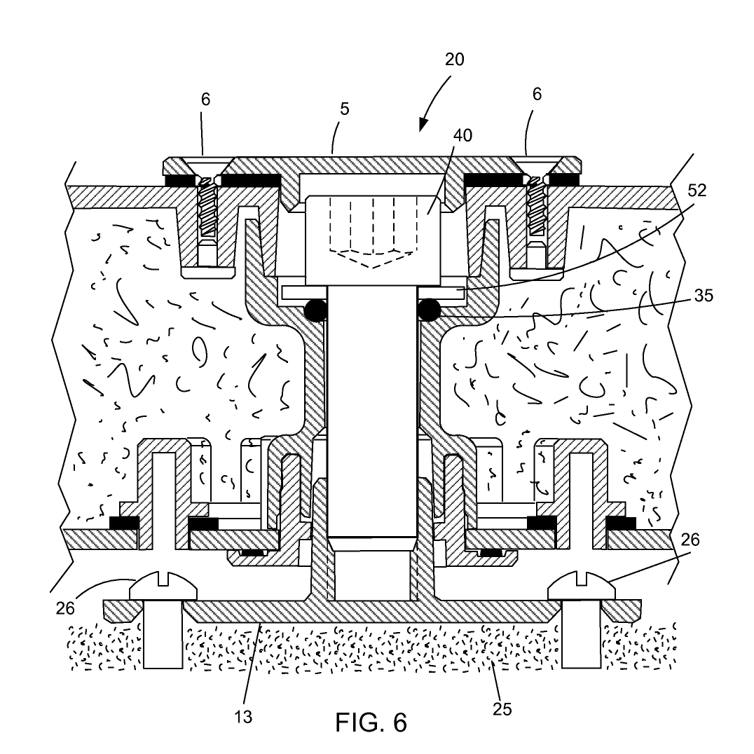

FIG. 6 shows locking mechanism 20 when safe 21 is locked to a concrete floor. In FIG. 6, bottom cover 13 is screwed to concrete floor 25 with bolts 26. Safe 21 is supported in the vertical position shown in FIG. 6 by feet 30 (FIG. 11). Locking bolt 40 is threaded into bottom cover 13 so that safe 21 is anchored to concrete floor 35. In FIG. 6, the interior of safe 21 is protected from water, humidity and smoke by virtue of gasket 7 and O-ring 35.

In FIG. 6, bottom cover 13 is functioning as an anchor nut element in that it is anchored to the floor and in that its threads receive locking bolt 40. Safe 21 closely covers bottom cover 13 so that it is impossible for a thief to reach bottom cover 13 when the safe is locked and closed. When locking mechanism 20 is in the position shown in FIG. 6, safe 21 cannot be removed from the floor without destroying the floor.

### Utilization of a Preferred Embodiment

In a preferred embodiment of the present invention, locking mechanism 20 is in the position shown in FIG. 1 when safe 21 is in route during transportation.

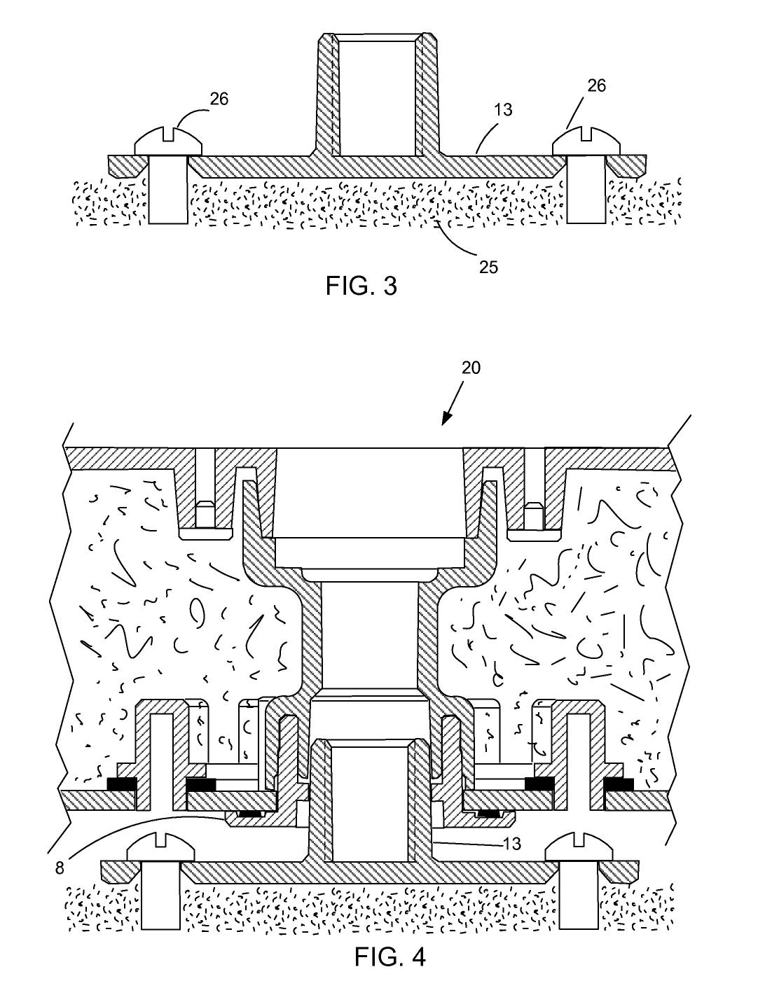

After determining the location for locking the safe to the floor, the user unscrews bottom cover 13 from locking mechanism 20. The user then screws bottom cover 13 to concrete floor 25 using bolts 26 as shown in FIG. 3.

As shown in FIG. 4, the user removes top cover 5 from locking mechanism 20. The user then slides outer tube 8 over bottom cover 13. The weight of the safe is supported by safe feet 30 (FIG. 11).

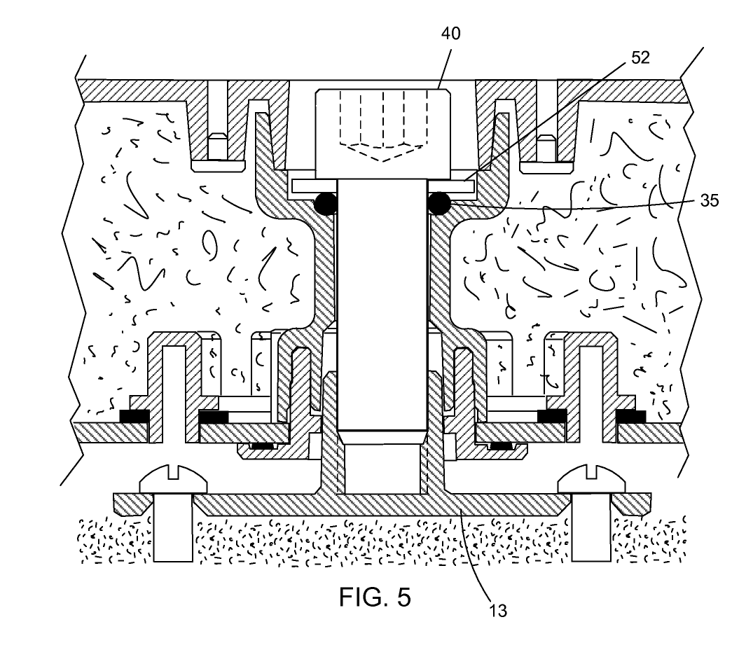

As shown in FIG. 5, locking bolt 40 is inserted through the opening of inner tube 4. Locking bolt 40 is tightly threaded onto bottom cover 13.

As shown in FIG. 6, top cover 5 is tightly reattached to interior housing 1 via screws 6. O-ring 35 and gasket 7 provide watertight and airtight protection for the interior of safe 21. From the position shown in FIG. 6, it is impossible to remove safe 21 from the floor without first destroying the floor.

### Preferred Components of the Present Invention

### Top Cover

Top cover 5 (shown in FIGS. 1, 2 and 7) is screwed tightly down against the top side of interior housing 1 via self tapping screws 6. Rubber plugs 16 are attached to interior housing 1 as shown and function to provide a seal between insulation 3. Gasket 7 functions to provide a watertight and airtight seal for the protection of the interior of safe 21.

### Bottom Cover

Bottom cover 13 is shown in FIGS. 1, 2 and 9. In FIG. 1 bottom cover 1 is shown in a position during which safe 21 is not locked to a floor (for example, during a transport or delivery of safe 21). Bottom cover 13 is screwed against the bottom of exterior housing 2. Screws are screwed into threads of screw sleeves 9. Gasket 15 functions to provide an airtight and watertight seal for the interior of safe 21. Gasket 10 functions to provide an airtight watertight seal for protection of insulation 3.

When locking mechanism 20 is used to lock safe 21 to the floor, bottom cover 13 is unscrewed from screw sleeves 9 and bolted to the floor. When bottom cover 13 is bolted to the floor, bottom cover 13 is functioning as an anchoring nut element to receive locking bolt 40 (FIG. 6). FIG. 3 shows bottom cover 13 screwed to the floor 25 with bolts 26.

### Inner Tube

FIGS. 1 and 4 show inner tube 4. At its top inner tube 4 is spin welded to groove 50 of interior housing 1. At its bottom inner tube 4 is spin welded to outer tube 8.

### Outer Tube

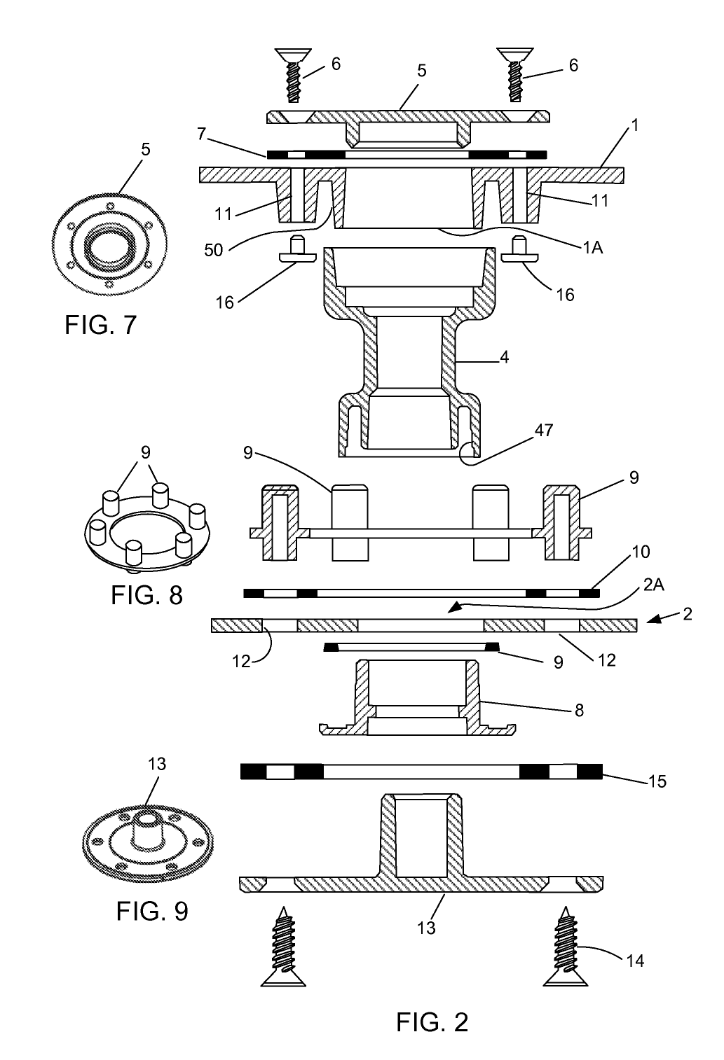

Outer Tube 8 is shown in FIGS. 1 and 2. Outer tube 8 is spin welded to groove 47 of inner tube 4 at its top end. At its bottom end outer tube 8 is pressed tight against the bottom side of exterior housing 2. O-ring 9 provides an airtight and water tight seal. Outer tube 8 is spin welded to inner tube 4 to form a tunnel between interior housing 1 and exterior housing 2.

### Screw Sleeves

Screw Sleeves 9 are shown in FIGS. 1, 2 and 8. Screw sleeves 9 are pressed fit into external housing 2. Gasket 10 provides watertight protection for insulation 3. Screw sleeves 9 include internal threads for receiving screws 14.

### Locking Bolt

Locking bolt 40 is shown in FIG. 6. Locking bolt 40 is threaded into threads on bottom cover 13. Washer 52 is under the head of bolt 40 and pressed down on o-ring 35. O-ring 35 provides water tight/air tight protection for the interior of safe 21.

Although the above-preferred embodiments have been described with specificity, persons skilled in this art will recognize that many changes to the specific embodiments disclosed above could be made without departing from the spirit of the invention. For example, although the above description of the preferred embodiments focused on utilizing the present invention to anchor a safe to a floor, the same locking mechanism can be attached to the back wall of the safe and the locking mechanism could be utilized to anchor the safe to a vertical wall. Therefore, the attached claims and their legal equivalents should determine the scope of the invention.

What is claimed is:

1) A safe anchoring device for anchoring a safe to a floor or wall and for providing watertight and airtight seal for the interior of the safe, said safe anchoring device comprising:
A) interior housing,
B) exterior housing,
C) insulation between said interior housing and said exterior housing,
D) a tunnel connecting said interior housing to said exterior housing,
E) a removable top cover for covering said tunnel at said interior housing,
F) a removable threaded locking bolt for extending through said tunnel for anchoring said safe to the floor, and
G) a bottom cover comprising a threaded tube section for receiving said threaded locking bolt,
wherein said removable threaded locking bolt is removed and wherein said bottom cover is for covering said tunnel at said exterior housing when said safe is not anchored to the floor, wherein said bottom cover is rigidly attached to the floor and said locking bolt is threaded onto said threaded tube section when said safe is anchored to the floor.

2) The safe anchoring device as in claim 2, wherein said tunnel comprises:
A) an inner tube rigidly attached to said interior housing, and
B) an outer tube rigidly attached to said inner tube and pressed tightly against said exterior housing.

3) The safe anchoring device as in claim 2, further comprising a plurality of screw sleeves rigidly connected to said exterior housing wherein said bottom cover is rigidly connected to said exterior housing via screws threaded in said plurality of screw sleeves.

4) The safe anchoring device as in claim 3, further comprising a bottom cover gasket between said bottom cover and said exterior housing, said bottom cover gasket providing said watertight and airtight seal for the interior of the safe.

5) The safe anchoring device as in claim 1, wherein said top cover is rigidly connected to said interior housing via screws threaded into said interior housing.

6) The safe anchoring device as in claim 5 further comprising a top cover gasket between said top cover and said interior housing, said top cover gasket providing said watertight and airtight seal for the interior of the safe.

7) The safe anchoring device as in claim 1, wherein said locking bolt further comprises:
A) a bolt head, and
B) a bolt O-ring under said bolt head,
wherein said bottom cover is securely attached to the floor, wherein said tunnel is slid over said threaded tube section, wherein said locking bolt is threaded into said threaded tube section, wherein said bolt O-ring provides said watertight and airtight seal for the interior of the safe.

8) The safe anchoring device as in claim 7, further comprising a top cover gasket between said top cover and said interior housing, wherein said top cover gasket provides said watertight and airtight seal for the interior of the safe.

9) The safe anchoring device as in claim 1, further comprising:
A) a top cover gasket between said top cover and said interior housing,
B) a bottom cover gasket between said bottom cover and said exterior housing,
wherein said top cover gasket and said bottom cover gasket provide said watertight and airtight seal for the interior of the safe.

10) A safe anchoring device for anchoring a safe to a floor or wall and for providing watertight and airtight seal for the interior of the safe, said safe anchoring device comprising:
A) interior housing,
B) exterior housing,
C) insulation between said interior housing and said exterior housing,
D) an inner tube rigidly attached to said interior housing,
E) an outer tube rigidly attached to said inner tube and pressed tightly against said external housing.
F) a removable top cover for covering said inner tube,
G) a top cover gasket between said top cover and said interior housing and covering said inner tube, said top cover gasket providing said watertight and airtight seal for the interior of the safe,
H) a removable threaded locking bolt for extending through said inner tube and said outer tube and for anchoring said safe to the floor,
I) a bottom cover comprising a threaded tube section for receiving said threaded locking bolt,
J) a bottom cover gasket between said bottom cover and said exterior housing and covering said outer tube, said bottom cover gasket providing said watertight and airtight seal for the interior of the safe,
wherein said removable threaded locking bolt is removed and wherein said bottom cover is for covering said outer tube when said safe is not anchored to the floor, wherein when said safe is anchored to the floor said bottom cover is rigidly attached to the floor and said locking bolt is threaded onto said threaded tube section.

11) A safe anchoring device for anchoring a safe to a floor or wall, said safe anchoring device comprising:
A) an anchoring nut element securely attached to the floor or wall, wherein said anchoring nut element is closely covered by said safe to prevent detachment of said safe anchoring nut element from said floor or wall,
B) a bolt element extending from the interior of said safe through said safe and bolted to said anchoring nut element,
wherein once said safe is closed and locked said safe cannot be removed from the anchoring nut element without destroying said floor or wall.

12) The safe anchoring device as in claim 11, wherein said safe comprises:
A) interior housing,
B) exterior housing, and
C) insulation between said interior housing and said exterior housing,
wherein said bolt element extends from the interior of said safe through said interior housing and is bolted to said anchoring nut element covered by said exterior housing.
